(19) United States
(12) Patent Application Publication
(10) Pub. No.: US 2011/0225962 A1
(43) Pub. Date: Sep. 22, 2011

(54) Variable Speed Hydraulic Pump Apparatus and Method

(75) Inventor: Michael T. Landrum, Rockford, IL (US)

(73) Assignee: SPX CORPORATION, Charlotte, NC (US)

(21) Appl. No.: 12/728,509

(22) Filed: Mar. 22, 2010

(51) Int. Cl. F15B 11/04; B23P 11/00; F04B 17/00

(52) U.S. Cl. 60/459; 29/888.02; 417/390

(57) ABSTRACT

An embodiment in accordance with the present invention provides a hydraulic pump including a first motor running at a fixed speed, a reservoir for fluid and a first pump operatively coupled to the motor such that the pump runs at the same speed as the motor and generates a flow of fluid from the reservoir. The hydraulic pump further includes a second motor, a speed control valve operatively coupled to the to the first pump and operatively coupled to the second motor such that a portion of the flow is directed to the second motor and the remainder of the flow is diverted to the reservoir, and a second pump operatively coupled to the second motor such that the second pump is driven by the second motor.

### FIELD OF THE INVENTION

The present invention relates generally to a pump. More particularly, the present invention relates to a variable speed hydraulic pump.

### BACKGROUND OF THE INVENTION

Adjustable flow output hydraulic pumps have proven to be very useful in applications such as synchronous lifting or where precise control of high pressure hydraulic flow is needed. However, generally adjustable flow output pumps require use of a variable angle swash plate. These variable angle swash plates are complicated and expensive to produce.

Accordingly, it is desirable to provide a variable speed hydraulic pump having a design that does not require the use of a variable angle swash plate.

### SUMMARY OF THE INVENTION

The foregoing needs are met, to a great extent, by the present invention, wherein in one aspect an apparatus is provided that in some embodiments includes a design for a variable speed hydraulic pump.

In accordance with one aspect of the present invention, a hydraulic pump includes a first motor running at a fixed speed, a reservoir for fluid and a first pump operatively coupled to the motor such that the pump runs at the same speed as the motor and generates a flow of fluid from the reservoir. The hydraulic pump further includes a second motor, a speed control valve operatively coupled to the first pump and operatively coupled to the second motor such that a portion of the flow is directed to the second motor and the remainder of the flow is diverted to the reservoir, and a second pump operatively coupled to the second motor such that the second pump is driven by the second motor.

In accordance with another aspect of the present invention the hydraulic pump includes one of a fixed speed prime mover, electric motor, air motor, or gas motor to power the unit. In addition the first pump can take the form of a variable flow low pressure pump, a gerotor, or a vane. The speed of the hydraulic pump can be operated manually via the speed control valve. Alternately, it can be operated by a solenoid or a pilot. The hydraulic pump can also include a fixed angle plate.

In accordance with another aspect of the present invention, a hydraulic pump includes a motor means and a means for containing a fluid. The hydraulic pump can further include a first means for pumping a fluid operatively coupled to the motor means such that the means for pumping a fluid runs at the same speed as the motor means and generates a flow of fluid from the reservoir, a second motor means, and a means for controlling speed operatively coupled to the to the first pump and operatively coupled to the second motor such that a portion of the flow is directed to the second motor and the remainder of the flow is diverted to the reservoir. The hydraulic pump can also include a second means for pumping the fluid operatively coupled to the second motor means such that the second pump is driven by the second motor means.

In accordance with another embodiment of the present invention, the first motor means takes the form of one of a fixed speed prime mover, electric motor, air motor, or gas motor. The first means for pumping the fluid can take the form of a variable flow low pressure pump, a gerotor, or a vane. Additionally, the means for controlling speed can be operated manually, by a solenoid, or by a pilot. The second means for pump can also include a fixed angle plate.

In accordance with still another embodiment of the present invention, a method of manufacturing a hydraulic pump includes coupling a first motor to a fixed speed pump such that the fixed speed pump runs at the same speed as the motor and coupling the fixed speed pump to a speed control valve. The method also includes coupling the speed control valve to a second motor such that the speed control valve passes a flow of a fluid to the second motor in order to achieve a predetermined speed for the second motor and coupling the second motor to a variable speed high pressure pump, such that the variable speed high pressure pump is driven by the second motor.

In accordance with another embodiment of the present invention the method of manufacturing the hydraulic pump can also include the first motor taking the form of one of a fixed speed prime mover, electric motor, air motor, or gas motor. The first pump can take the form of one of a gerotor or a vane. The speed control valve can be operated manually, by a solenoid, or by a pilot. Additionally, the second pump can include a fixed angle plate.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a schematic view of a variable speed hydraulic pump in accordance with an embodiment of the invention.

FIG. 2 illustrates a schematic view of a speed control pump in accordance with an embodiment of the invention.

FIG. 3 illustrates a method in accordance with an embodiment of the invention.

### DETAILED DESCRIPTION

The invention will now be described with reference to the drawing figures, in which like reference numerals refer to like parts throughout. An embodiment in accordance with the present invention provides a hydraulic pump including a first motor running at a fixed speed, a reservoir for fluid and a first pump operatively coupled to the motor such that the pump runs at the same speed as the motor and generates a flow of fluid from the reservoir. The hydraulic pump further includes a second motor, a speed control valve operatively coupled to the to the first pump and operatively coupled to the second motor such that a portion of the flow is directed to the second motor and the remainder of the flow is diverted to the reservoir, and a second pump operatively coupled to the second motor such that the second pump is driven by the second motor.

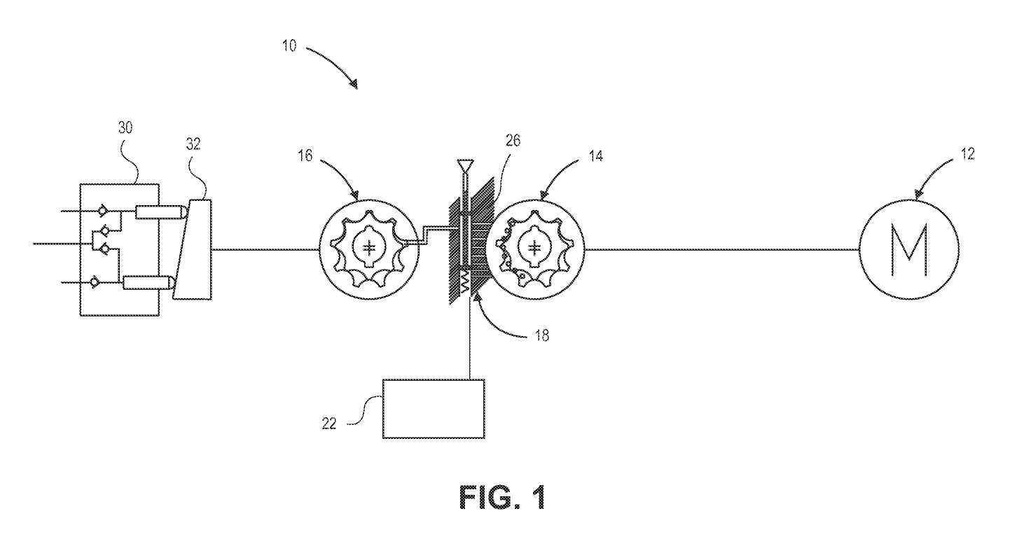

An embodiment of the present inventive apparatus is illustrated in FIG. 1. FIG. 1 illustrates a schematic view of a variable speed hydraulic pump 10 in accordance with an embodiment of the in. The variable speed hydraulic pump 10 includes a first motor 12 coupled to a first pump 14. The first pump 14 drives a second motor 16, and, in turn the second motor is coupled to a speed control valve 18. The speed control valve 18 is positioned between the first pump 14 and the second motor 16 and can limit the flow from the first pump 14 into the second motor 16.

The first motor 12 can take the form of a fixed speed prime mover that runs on electric, air, or gas power. Alternately, the first motor 12 can take the form of any fixed speed motor suitable for driving a variable speed hydraulic pump. The first motor 12 can also be turned on and left to run at a fixed speed. The first pump 14 is operatively coupled to the first motor 12, such that the first motor 12 drives the first pump 14. Because the first motor 12 can take the form of a fixed speed motor, the first pump 14 also operates at a fixed speed. The first pump 14 can take the form of a variable flow low pressure pump, such as a gerotor or a vane. Alternately, the first pump 14 can be any pump suitable for creating a fluid output for the variable speed hydraulic pump 10. Fluid from tank 22 enters the first pump 14 and is then expelled from the first pump 14 in the form of fluid output. The output portion of the first pump 14 can be divided by the speed control valve 18. the speed control valve includes a series of outlet ports, slots, or holes 26, to allow all or part of the flow to be directed either to the next stage or back to the tank 22. The speed control valve 18 can be operated in a number of ways including manually, by a pilot, or by a solenoid. The first pump 14 moves at the same speed as the first motor 12.

Fluid from the tank 22 is expelled from the first pump 14 in the form of fluid output through the holes 26 in the speed control valve 18 and into the second motor 16. Preferably, the second motor 16 takes the form of a hydraulic motor and is driven by the fluid output from the speed control valve 18. The second motor 16 will, therefore, have a variable speed due to the potential variation in the amount of fluid input from the speed control valve 18. If it is desired that the second motor 16 move at a fast speed, the output from the speed control valve 18 can be increased. Alternately, if it is desired that the second motor move at a slower speed, the output from the speed control valve 18 can be decreased. The speed of the second motor 16 is completely independent from the first motor 12. Therefore, the second motor 16 can act as a nearly infinitely variable hydraulic transmission.

The second motor 16 is coupled to a high pressure pump 30, which is driven directly by the output of the second motor 16 through fixed angle plate 32 and will operate at the same speed as the second motor 16. Therefore, the speed of the high pressure pump 30 is also controlled by the speed control valve 18. By using the fixed angle plate 32 there is no extra fluid compression due to enlarged oil column within the pump, which can occur when a variable angle swash plate is used.

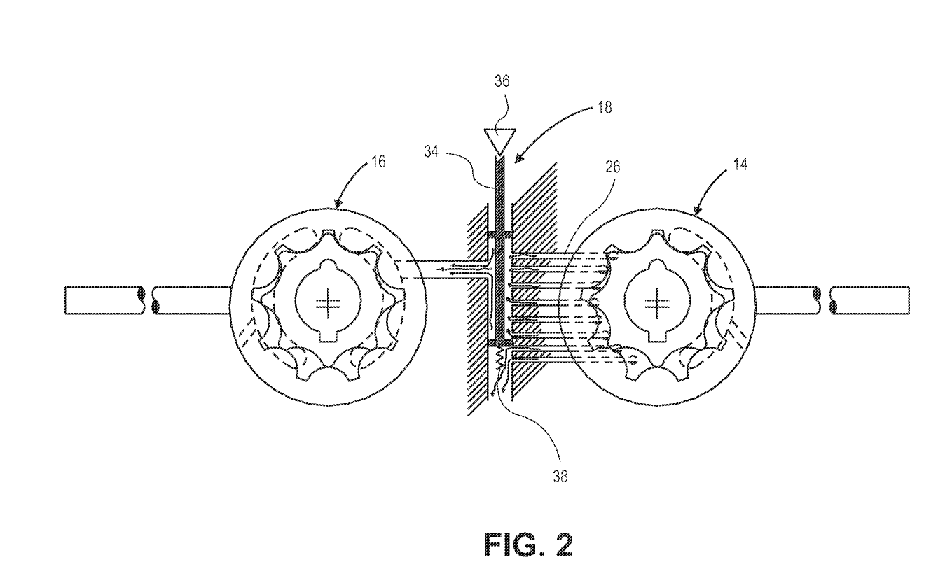

FIG. 2 illustrates a detailed view of the speed control valve 18. The speed control valve 18 is coupled to the first pump 14 via holes 26. As shown in FIG. 2, fluid flows into the holes 26 from the first pump 14. Holes 26 are isolated from each other by the open or closed condition of the gerotor lobes. The flow through holes 26 is then either passed through to second motor 16 or diverted to tank 22 (not shown) at nearly zero psi. The flow is controlled by speed control valve 18, which, as shown in FIG. 2, includes a spool 34 driven by a pilot 36. The spool 34 is biased against a spring 38. The position of spool 34 can be changed in order to increase or decrease the amount of fluid passed through to the second motor 16, thereby increasing or decreasing the speed of the second motor. While the speed control valve is shown with a spool 34 biased against spring 38 and driven by pilot 36 any other means of providing a speed control valve could be used. For example, the speed control valve could also be operated manually or by a solenoid.

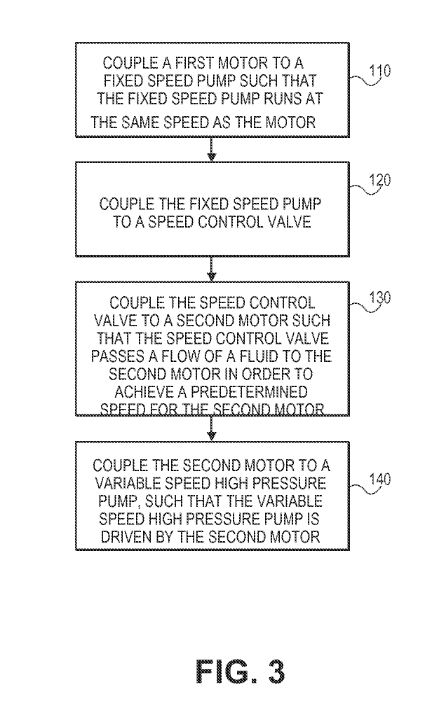

FIG. 3 illustrates a method in accordance with an embodiment of the invention. At step 110, a first motor is coupled to a fixed speed pump such that the fixed speed pump runs at the same speed as the motor. At step 120 the fixed speed pump is coupled to a speed control valve, and at step 130 the speed control valve is coupled to a second motor such that the speed control valve passes a flow of a fluid to the second motor in order to achieve a predetermined speed for the second motor. Additionally, step 140 includes coupling the second motor to a variable speed high pressure pump, such that the variable speed high pressure pump is driven by the second motor.

The method of manufacturing the hydraulic pump can also include the first motor taking the form of one of a fixed speed prime mover, electric motor, air motor, or gas motor. The first pump can take the form of one of a gerotor or a vane. The speed control valve can be operated manually, by a solenoid, or by a pilot. Additionally, the second pump can include a fixed angle plate.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A hydraulic pump comprising:
a first motor running at a fixed speed;
a reservoir for fluid;
a first pump operatively coupled to the motor such that the pump runs at the same speed as the motor and generates a flow of fluid from the reservoir;
a second motor;
a speed control valve operatively coupled to the first pump and operatively coupled to the second motor such that a portion of the flow is directed to the second motor and the remainder of the flow is diverted to the reservoir;
a second pump operatively coupled to the second motor such that the second pump is driven by the second motor.

2. The hydraulic pump of claim 1 wherein the first motor comprises one of a fixed speed prime mover, electric motor, air motor, or gas motor.

3. The hydraulic pump of claim 1 wherein the first pump comprises a variable flow low pressure pump.

4. The hydraulic pump of claim 1 wherein the first pump comprises one of a gerotor or a vane.

5. The hydraulic pump of claim 1 wherein the speed control valve is operated manually.

6. The hydraulic pump of claim 1 wherein the speed control valve is operated by one of a solenoid or a pilot.

7. The hydraulic pump of claim 1 wherein the second pump comprises a fixed angle plate.

8. A hydraulic pump comprising:
a motor means;
a means for containing a fluid;
a first means for pumping a fluid operatively coupled to the motor means such that the means for pumping a fluid runs at the same speed as the motor means and generates a flow of fluid from the reservoir;
a second motor means;
a means for controlling speed operatively coupled to the first pump and operatively coupled to the second motor such that a portion of the flow is directed to the second motor and the remainder of the flow is diverted to the reservoir;
a second means for pumping the fluid operatively coupled to the second motor means such that the second pump is driven by the second motor means.

9. The hydraulic pump of claim 8 wherein the first motor means comprises one of a fixed speed prime mover, electric motor, air motor, or gas motor.

10. The hydraulic pump of claim 8 wherein the first means for pumping the fluid comprises a variable flow low pressure pump.

11. The hydraulic pump of claim 8 wherein the first means for pumping the fluid comprises one of a gerotor or a vane.

12. The hydraulic pump of claim 8 wherein the means for controlling speed is operated manually.

13. The hydraulic pump of claim 8 wherein the means for controlling speed is operated by one of a solenoid or a pilot.

14. The hydraulic pump of claim 8 wherein the second means for pump comprises a fixed angle plate.

15. A method of manufacturing a hydraulic pump comprising: coupling a first motor to a fixed speed pump such that the fixed speed
pump runs at the same speed as the motor;
coupling the fixed speed pump to a speed control valve;
coupling the speed control valve to a second motor such that the speed control valve passes a flow of a fluid to the second motor in order to achieve a predetermined speed for the second motor; and
coupling the second motor to a variable speed high pressure pump, such that the variable speed high pressure pump is driven by the second motor.

16. The method of claim 15 further comprising the first motor comprising of one of a fixed speed prime mover, electric motor, air motor, or gas engine.

17. The method of claim 15 further comprising the first pump comprising one of a gerotor or a vane.

18. The method of claim 15 further comprising installing a speed control valve capable of being operated manually.

19. The method of claim 15 wherein the speed control valve is operated by one of a solenoid or a pilot.

20. The method of claim 15 wherein the second pump comprises a fixed angle plate.
